(19) United States
(12) Patent Application Publication
(10) Pub. No.: US 2007/0222589 A1
(43) Pub. Date: Sep. 27, 2007

(54) Identifying security threats

(76) Inventors: Richard Gorman, San Mateo, CA (US); Edward Abbo, San Mateo, CA (US); Anthony James Butitta, Saint Louis Park, MN (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 10/185,871

(22) Filed: Jun. 27, 2002

(51) Int. Cl. G06F 15/173; G08B 1/08; H04Q 7/00

(52) U.S. Cl. 340/539.26; 709/223

(57) ABSTRACT

A method, system, and computer-readable medium is described for analyzing information to assist security personnel in identifying security threats. In some situations, various threat trend analyses are used to identify trends in various security-related information, and trend analysis information may then be presented to appropriate users (e.g., via displayed graphical charts). In a similar manner, in some situations various types of threat alerts are used to notify appropriate personnel when current conditions trigger the alert, such as in a real-time manner. In some situations, the trend analyses and alerts are selected for a user based on a current role of the user, and in some situations the information about a possible security threat is provided to various security personnel that are determined to be appropriate for the information, such as security personnel in affected geographical locations or that have capabilities related to preventing or addressing such threats.

### CROSS REFERENCE TO RELATED APPLICATIONS

This application is related to U.S. patent application Ser. No.______ (Attorney Docket # 38481.8027), filed concurrently and entitled “Method and System for Processing Intelligence Information”, and to U.S. patent application Ser. No.______ (Attorney Docket # 38481.8029), filed concurrently and entitled “Disseminating Information About Security Threats”, both of which are hereby incorporated by reference in their entirety.

### TECHNICAL FIELD

The following disclosure relates generally to analyzing information related to security threats, and more particularly to identifying possible security threats in order to enable notification of appropriate personnel, such as to alert appropriate personnel so that they can prevent identified terrorism threats.

### BACKGROUND

As the security of governments, organizations (e.g., businesses) and individuals is increasingly threatened by various groups and individuals (e.g., terrorist groups and their members), it is increasingly important to identify future security threats (e.g., planned attacks) before they occur so that they can be prevented. In many cases, security personnel (e.g., law enforcement officials) whose job it is to prevent or address such security threats do not have access to the necessary information to identify the security threats before they occur (e.g., information about attack preparation activities of terrorist groups). In other situations, security personnel may have access to the necessary information, but that information may be obscured in an over-abundance of other irrelevant information of various types and/or it may be in an unanalyzed form from which it is difficult to identify the security threats.

Accordingly, it would be beneficial to provide techniques to analyze various types of information related to possible security threats in an automated manner, such as to assist security personnel in identifying future security threats.

### BRIEF DESCRIPTION OF THE DRAWINGS

FIG. 1 shows a multi-layered system architecture within which the described techniques can be implemented.

FIG. 2 shows a block diagram of one embodiment of a system configuration in which the described techniques can be implemented.

FIG. 3 shows a block diagram illustrating a logical representation of a multi-layered architecture within which the described techniques can be implemented.

FIG. 4 illustrates a block diagram of one embodiment of an application framework within which the described techniques can be implemented.

FIGS. 5A-5H illustrate examples of analyzing security-related information to identify possible security threats.

FIG. 6 is a block diagram illustrating an embodiment of a computing system suitable for performing the described techniques.

FIG. 7 is a flow diagram of an embodiment of the Threat Trend Analyzer routine.

FIG. 8 is a flow diagram of an embodiment of the Threat Alert Generator routine.

### DETAILED DESCRIPTION

I. Introduction

A software facility is described below that provides various techniques for analyzing information to assist security personnel in identifying security threats. Various types of information analyses can be performed in various embodiments, and in some embodiments the information analyses vary by user (e.g., based on a current role of the user). Similarly, the types of information that are analyzed can vary in various embodiments, such as information about recent activities of individuals or groups that are suspected of being involved in previous and/or future security threats, or information about diseases or other health risks (e.g., chemical or biological) that may be naturally spread or otherwise disseminated.

In particular, in some embodiments various types of threat trend analyses can be used to identify trends in one or more types of security-related information. A threat trend analysis may use one or more measurement criteria to calculate threat values for a type of security-related information over a period of time, such as for each of multiple time units within that period of time (e.g., each week in a month, or each day in a year). Trends over that period of time in the calculated threat values can then be identified using various automated and/or manual techniques. Information about the threat values and the corresponding trends may be presented to users that have requested the information or are otherwise associated with the information in various ways, such as via graphical charts presented on a computing device. Such information can also be provided to other appropriate users, such as security personnel (e.g., law enforcement, military, intelligence gathering, health, government, business, etc.) in affected geographical locations or that have capabilities related to preventing or addressing threats.

For example, a significantly increasing trend in activities of a particular terrorist group in a particular geographic location may indicate that an attack by that group will soon occur in the geographic location. The threat values that are calculated for such terrorist group activities may use a variety of types of measurement criteria, such as based on a total number of activities, by weighting some activities more highly than others, by correlating different types of activities that may be related in various ways (e.g., in time, in geographical location, by the individuals involved, etc.), etc. Similarly, increasing trends in the number of reported cases of a communicable disease that simultaneously occur in multiple disparate geographic locations may indicate an intentional dissemination of that disease.

In addition, in some embodiments various types of threat alerts can be used to notify appropriate personnel when current conditions trigger the alert. A threat alert may be triggered by the satisfaction of a variety of types of alert criteria, such as a threshold for a particular type of security-related information, a specified combination of multiple types of security-related information, etc. In some embodiments, a threat alert may be associated with a threat trend analysis in such a manner that one or more calculated threat values or corresponding trend information for that threat trend analysis may trigger the alert. Information about a triggered threat alert may be provided to one or more users in various ways, such as in a real-time or near-instantaneous manner (e.g., via a pop-up message on a computing device, an instant message, a phone call or SMS message, an email, via a paging device, etc.). Appropriate security personnel to receive such information can be selected in a manner similar to that for threat trend analysis information.

II. System Overview and Overall Architecture

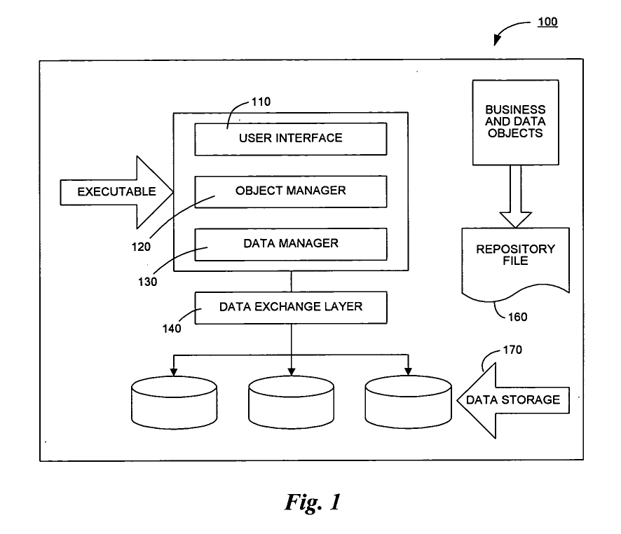

In one embodiment, a computing system with which the facility is integrated can be logically structured as a multi-layered architecture as shown in FIG. 1.

In particular, the logical multi-layered architecture as shown in FIG. 1 provides a platform for common services to support various applications. These services may include a user interface layer 110, an object manager layer 120, a data manager layer 130, and a data exchange layer 140.

The user interface layer 110 may provide a variety of high-level GUI elements such as applets, views, charts and reports that are associated with one or more applications. In one embodiment, various types of clients can be supported via the user interface layer 110. These various types of clients may include traditional connected clients, remote clients, thin clients over an intranet, Java thin clients or non-Windows-based operating systems, HTML clients over the Internet, etc.

The object manager layer 120 may be designed to manage one or more sets of business rules or business concepts associated with one or more applications and to provide the interface between the user interface layer 110 and the data manager layer 130. In one embodiment, the business rules or concepts can be represented as business (or “business process”) objects. The business objects may also be designed as configurable software representations of various business rules or concepts, such as accounts, contacts, opportunities, service requests, solutions, etc.

The data manager layer 130 may be designed to maintain logical views of the underlying data and to allow the object manager to function independently of underlying data structures or tables in which data are stored. In one embodiment, the data manager 130 may also provide certain database query functions such as generation of structure query language (SQL) in real-time to access the data. In one embodiment, the data manager 130 is designed to operate on object definitions in a repository file 160 that define the database schema. The data storage services 170 provide the data storage for the data model associated with one or more applications.

The data exchange layer 140 may be designed to handle the interactions with one or more specific target databases and to provide the interface between the data manager layer 130 and the underlying data sources.

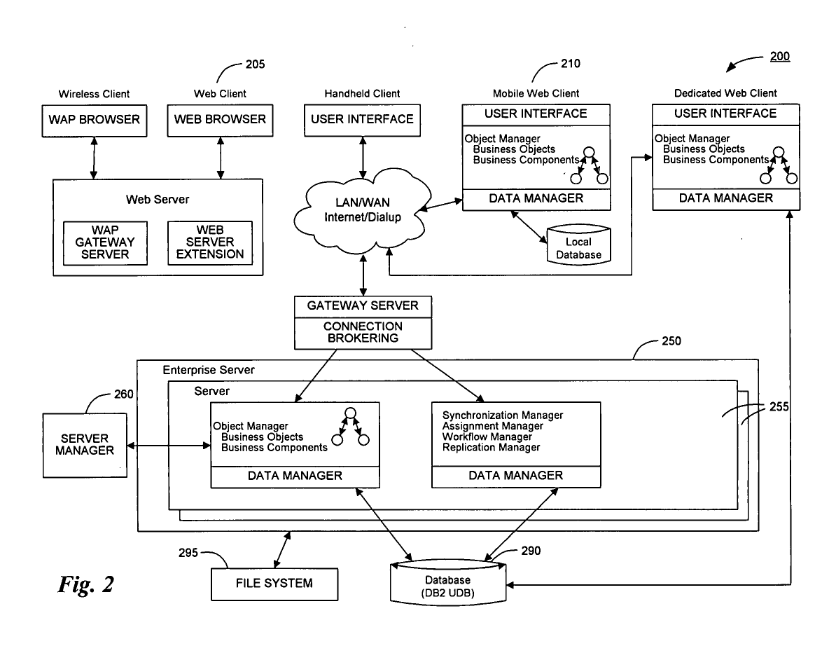

FIG. 2 shows a block diagram of one embodiment of a computing system configuration in which the facility can operate. In particular, the illustrated multi-layered architecture allows one or more software layers to reside on different machines. For example, the user interface, the object manager, and the data manager may all reside on the dedicated Web clients. For other types of clients such as the wireless clients, the object manager and data manager may reside on a system server. It should be appreciated and understood by one skilled in the art that the system configuration shown in FIG. 2 is for illustrative and explanative purposes, and may vary depending upon the particular implementations and applications of the described techniques.

In one embodiment, the system environment illustrated in FIG. 2 may include more than one database 290, and one or more subsets of the database can be created or replicated by a replication manager. In addition, mobile Web clients can have additional remote databases with respect to the database 290 (also referred to as local databases with respect to those clients). In one embodiment, unless the remote/local databases associated with the mobile Web clients are defined as read-only databases, these mobile Web clients can create and update data locally that will be ultimately propagated up to the primary database when each mobile Web client synchronizes with the system server.

In one embodiment, the database 290 is designed to store various types of data including predefined data schema (e.g., table objects, index objects, etc.), repository objects (e.g., business objects and components, view definitions and visibility rules, etc.), and users' and customers' data. Dedicated Web clients and server components, including those that operate in conjunction with the other types of clients, may connect directly to the database 290 and make changes in real-time. In addition, mobile Web clients may download a subset of the server's data to use locally, and periodically synchronize with the server database through the system server to update both the local and the server database.

In some embodiments, various tables included in the database 290 may be logically organized into the following types: data tables, interface tables, and repository tables, etc. In addition, data tables may be used to store user business data, administrative data, seed data, and transaction data, etc. In one embodiment, these data tables may be populated and updated through the various applications and processes. Data tables may also include the base tables and the intersection tables, etc. In one embodiment, base tables may contain columns that are defined and used by the various applications. In one embodiment, the base tables are designed to provide the columns for a business component specified in the table property of that business component. In one embodiment, intersection tables are tables that are used to implement a many-to-many relationship between two business components. They may also hold intersection data columns, which store information pertaining to each association. In one embodiment, intersection tables provide the data structures for association applets.

In one embodiment, interface tables are used to denormalize a group of base tables into a single table that external programs can interface to. In one embodiment, they may be used as a staging area for exporting and importing of data.

In one embodiment, repository tables contain the object definitions that specify one or more applications regarding:
the client application configuration;
the mapping used for importing and exporting data; and
rules for transferring data to mobile clients.

In one embodiment, the file system 295 is a network-accessible directory that can be located on an application server. In one embodiment, the file system 295 stores the physical files created by various applications, such as files created by third-party text editors, and other data that is not stored in the database 290. In one embodiment, physical files stored in the file system 295 can be compressed and stored under various naming conventions. In one embodiment, dedicated Web clients can read and write files directly to and from the file system 295. In one embodiment, mobile Web clients can have a local file system, which they synchronize with the server-based file system 290 periodically. In one embodiment, other types of client such as the wireless clients and the Web clients can access the file system 290 via the system server.

In one embodiment, the enterprise server 250 is a logical grouping of the system servers 255 that share a common table owner or a database, point to a common gateway server, and can be administered as a group using server manager 260. In one embodiment, the connection to the gateway server can be established via TCP/IP. In one embodiment, the enterprise server 250 can be scaled effectively by deploying multiple system servers 255 in the enterprise server 250, thus providing a high degree of scalability in the middle tier of applications.

In one embodiment, the server 255 runs one or multiple server programs. It handles the incoming processing requests and monitors the state of all processes on the server. In one embodiment, server programs are designed and configured to perform one or more specific functions or jobs including importing and exporting data, configuring the database, executing workflow and process automation, processing to support mobile Web clients for data synchronization and replication, and enforcing business rules, etc. In one embodiment, the server 255 can be an NT Service (under Windows NT operating system) or a daemon (e.g., a background shell process) under UNIX operating system. In one embodiment, the server 255 supports both multi-process and multi-threaded components and can operate components in batch, service, and interactive modes.

In one embodiment, the server manager 260 is configured as a utility that allows common control, administration and monitoring across disparate programs for the servers 255 and the enterprise server 250. In one embodiment, the server manager 260 can be used to perform the following tasks: start, stop, pause, and resume servers 255, components, and tasks; monitor status and collect statistics for multiple tasks, components, and servers within an enterprise server; and configure the enterprise server, individual servers, individual components, and tasks, etc.

In one embodiment, the gateway server can be configured as a logical entity that serves as a single entry point for accessing servers. In one embodiment, it can be used to provide enhanced scalability, load balancing and high availability across the enterprise server. In one embodiment, the gateway server may include a name server and a connection brokering component. In one embodiment, the name server is configured to keep track of the parameters associated with the servers. For example, the availability and connectivity information associated with the servers can be stored in the name server. The various components in the system can query the name server for various information regarding the servers' availability and connectivity. In a Windows NT environment, the name server can be run as a NT service. In a UNIX environment, the name server can run as a daemon process. In one embodiment, the connection brokering component is used to perform load balancing functions such as directing client connection requests to an appropriate server (e.g., the least-busy server).

In one embodiment, as illustrated in FIG. 2, the various types of clients that can be supported by the system may include the following clients: dedicated Web clients, mobile Web clients, Web clients, wireless clients, and handheld clients, etc.

In one embodiment, dedicated Web clients (also called connected clients) are connected directly to a database server for data access via a LAN or WAN connection. In one embodiment, these connected or dedicated Web clients do not store data locally. These dedicated Web clients can also access the file system directly. In one embodiment, the user interface, the object manager, and the data manager layers of the multi-layered architecture reside on the dedicated Web client.

In one embodiment, the mobile Web clients are designed and configured for local data access and thus can have their own local database and/or local file system. In one embodiment, mobile Web clients can interact with other components within the system via the gateway server. Through synchronization, the modifications from the local database and the server database can be exchanged.

In one embodiment, a Web client runs in a standard browser format from the client's machine. In one embodiment, the Web client can connect to a system server 255 through a Web server. In one embodiment, the system server 255 is designed and configured to execute business logic and access data from the database 290 and file system 295. In one embodiment, the Web client described herein is designed and configured to operate in an interactive mode. In one embodiment, the interactive Web client framework as described herein utilizes dynamically created objects implemented in JavaScript on the browser side that correspond to objects on the server side. In one embodiment, these dynamically created objects on the browser side may include the current view and its corresponding applets, the current business object and the corresponding business components, etc.

In one embodiment, wireless clients are essentially thin clients enabled on wireless devices. The wireless clients can use a wireless application protocol (WAP)-based user interface to communicate and exchange information/data with the system server.

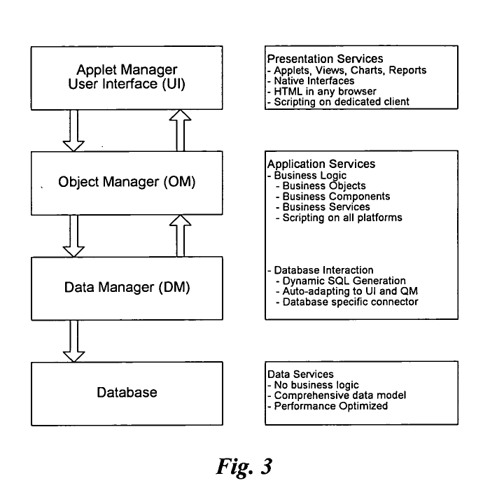

FIG. 3 shows a block diagram illustrating another logical representation of a multi-layered architecture. Again, the multi-layered architecture as illustrated in FIG. 3 provides the configured platform for various common services designed to support the various applications. In one embodiment, these various services may include presentation services which correspond to an applet manager and user interface layer, application services which correspond to an object manager (OM) layer and a data manager (DM) layer, and data services which correspond to a database layer.

In one embodiment, the presentation services may be designed and configured to support various types of clients and may provide them with user interface applets, views, charts, and reports, etc. As described above, a large variety of clients may be supported including wireless clients, handheld clients, Web clients, mobile Web clients, and dedicated (connected) clients, etc.

In one embodiment, the application services may include business logic services and database interaction services. In one embodiment, business logic services provide the class and behaviors of business objects and business components. In one embodiment, database interaction services may be designed and configured to take the user interface (UI) request for data from a business component and generate the database commands (e.g., SQL queries) necessary to satisfy the request. For example, the data interaction services may be used to translate a call for data into DBMS-specific SQL statements.

In one embodiment, data storage services may be designed and configured to provide the data storage for the underlying data model which serves as the basis of the various applications. For example, the data model may be designed and configured to support various software products and applications including call center, sales, services, and marketing, etc., as well as various industry vertical products and applications such as eFinance, eInsurance, eCommunications, and eHealthcare, etc.

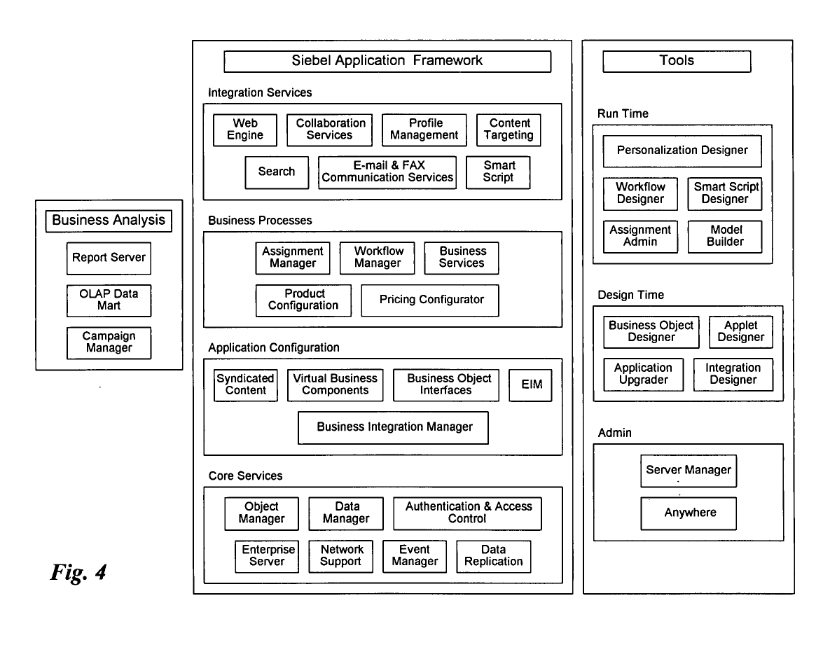

FIG. 4 illustrates a block diagram of one embodiment of an application framework. As illustrated in FIG. 4, the application framework may include various logical groupings of various types of services and various types of tools that can be used to design and configure particular applications based on business needs and environments.

In one embodiment, the core services are designed and configured to provide the framework in which the applications execute. In one embodiment, the core services may include the following:
the enterprise server, which is the middle-tier application server;
the networks that link all of these pieces together;
facilities like event manager and data replication, which allow sharing data between multiple installations of various applications as well as between the various applications and other external applications; and
the authentication and access control, the security facilities.

In one embodiment, application integration services may be designed and configured to allow the various applications built in accordance with this framework to communicate with the external world. In one embodiment, the various types of services in this logical grouping may be designed and configured to provide for real-time, near-real-time, and batch integration with external applications. For example, these integration services may be used to enable communications between external applications and the internal applications using available methods, technologies, and software products. In one embodiment, application integration services allow the systems or applications to share and replicate data with other external enterprise applications. Accordingly, these services allow a particular application or system to be both a client requesting information and a server having information requested from it.

In one embodiment, business processes services are designed and configured to allow the client to automate business processes through the application. In one embodiment, these various business process services may include the following:
assignment of tasks through Assignment Manager;
enforcement of business practices through Workflow Manager;
reuse of custom business logic through Business Services; and
ensuring proper product configuration and pricing through the Product Configurator and Pricing Configurator.

In one embodiment, creation of these business processes can be done through Run-Time tools such as Personalization Designer, Workflow Designer, SmartScript Designer, Assignment Administration Views, the Model Builder, etc.

In one embodiment, integration services may be designed and configured to provide the client with user interface and thin client support. In one embodiment, these may include capabilities for building and maintaining Web-based applications, providing Web support facilities such as user Profile Management, Collaboration Services and Email and Fax services, as well as advanced Smart Scripting, etc.

In one embodiment, design time tools may be designed and configured to provide the services to customize, design, provide integration points, and maintain the application. These various tools provide one common place to define the application.

In one embodiment, admin services are designed and configured to provide one place to monitor and administer the application environment. In one embodiment, these services allow the user to administer the application either through a graphic user interface (GUI) or from a command line.

III. Examples and Additional Details

For illustrative purposes, some embodiments of the software facility are described below in which specific types of security-related information is analyzed in specific types of ways, and in which the results of the analyses are provided to various specific types of users in various specific ways. However, those skilled in the art will appreciate that the techniques of the invention can be used in a wide variety of other situations, and that the invention is not limited to use with the illustrated types of analysis and notification techniques or with the illustrated types of security-related information or users.

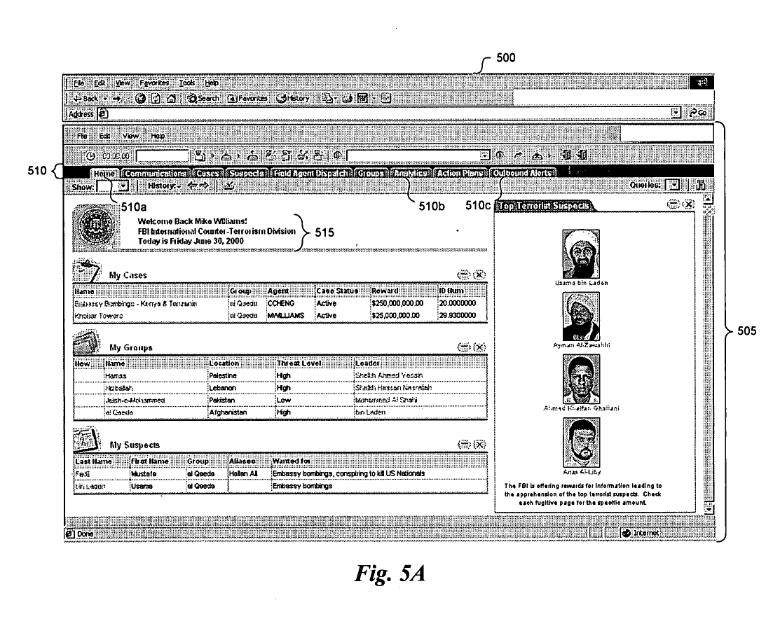

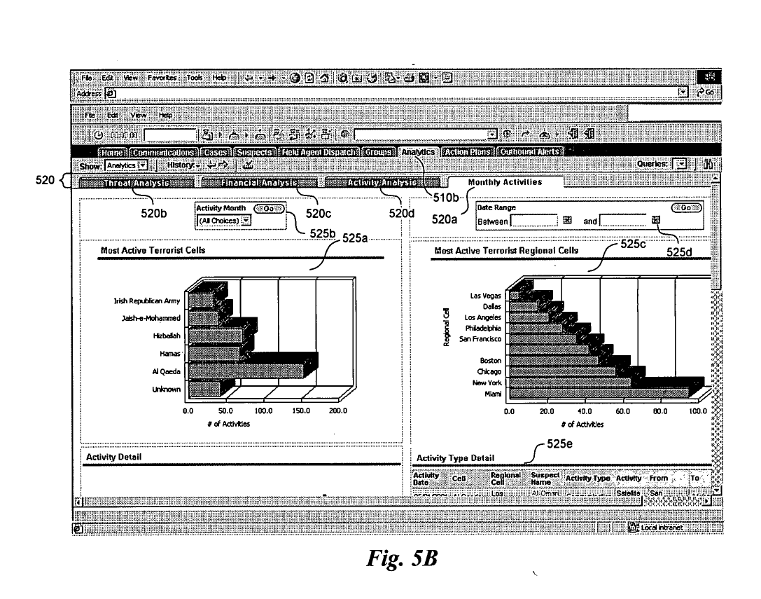

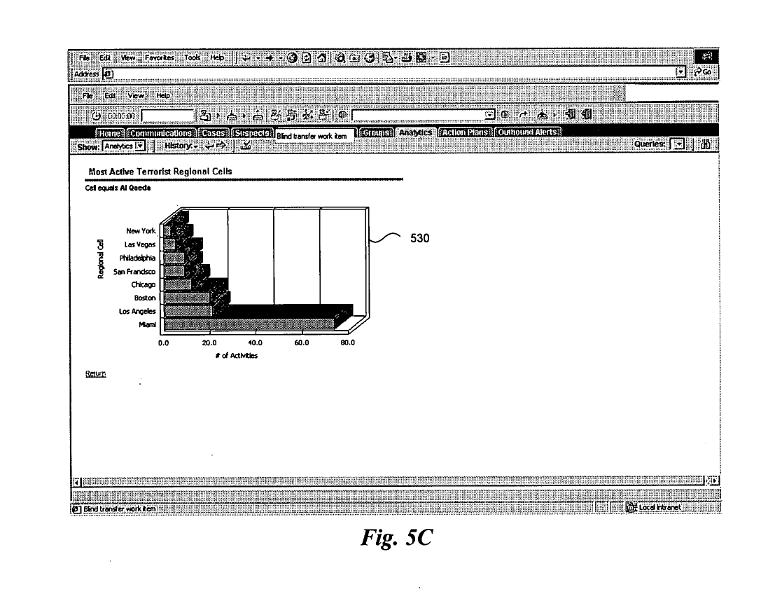

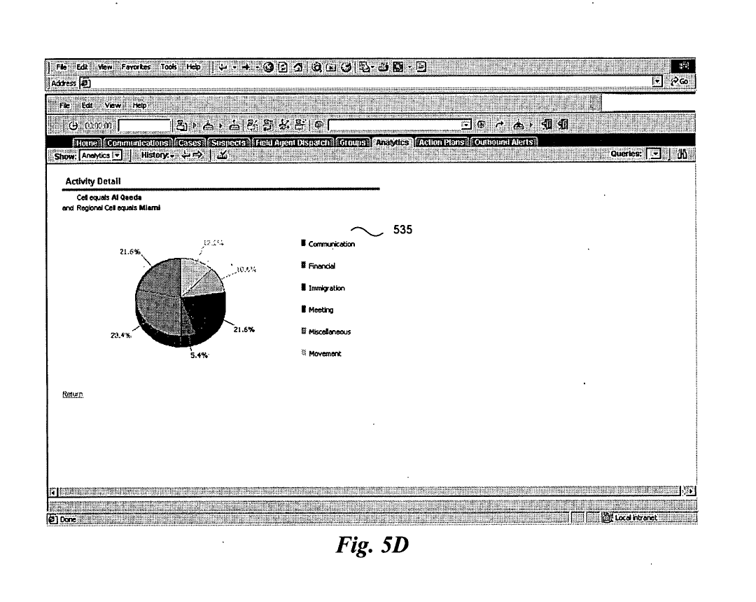

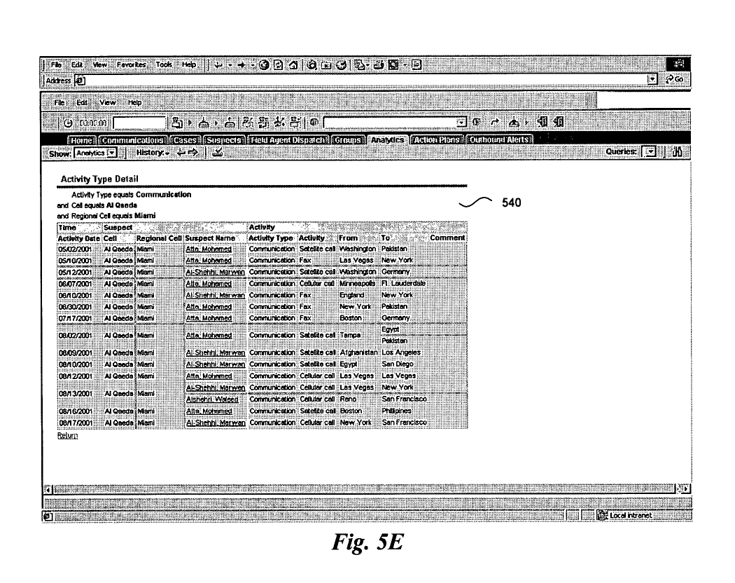

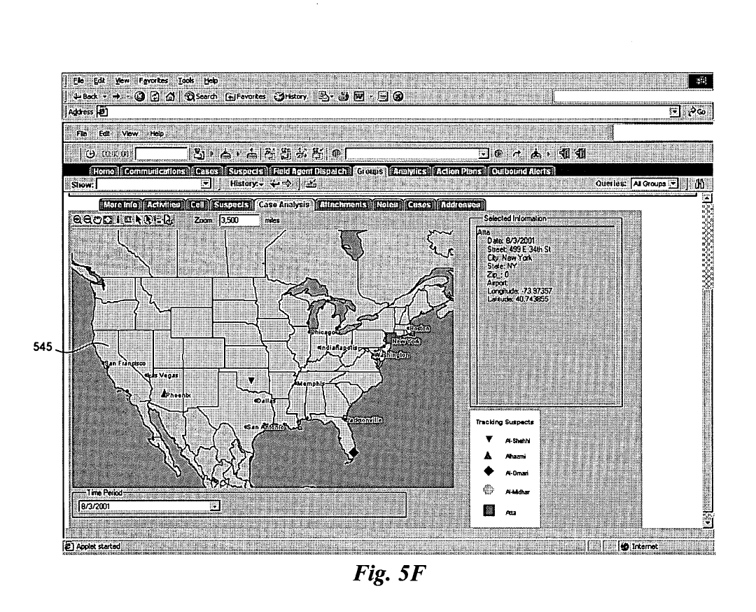

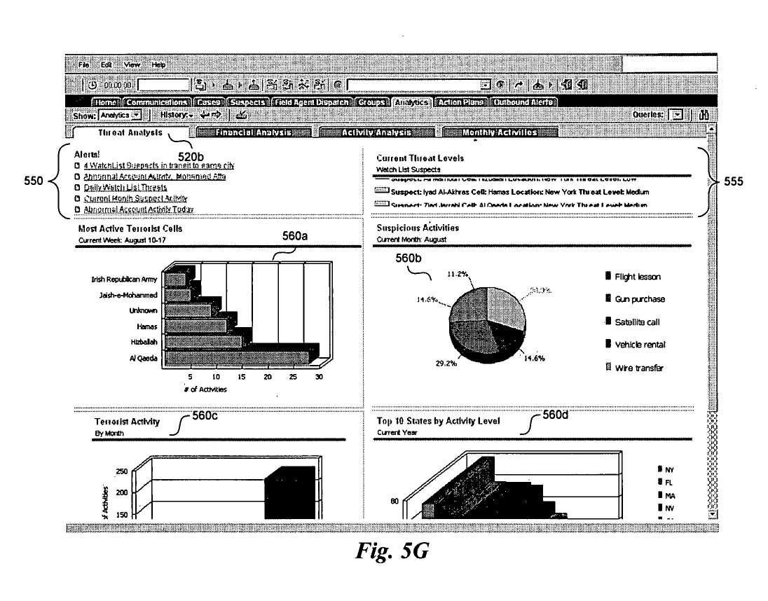

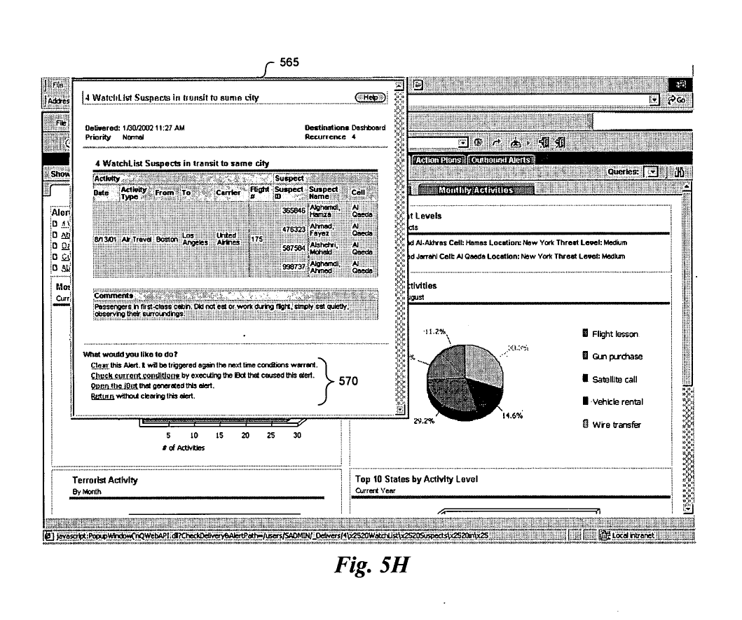

FIGS. 5A-5H illustrate examples of using automated techniques to analyze security-related information and identify possible security threats. In particular, in the illustrated embodiment a current user of a computing device is serving in a role as a member of a counter-terrorism governmental organization, and the facility assists the user in identifying possible future terrorist threats relevant to that role.

FIG. 5A illustrates an example displayed window 500 that includes a user interface 505 with a variety of information relevant to the counter-terrorism user.

In the illustrated embodiment, the information is presented as one or more Web pages, such as with a Web browser executing on the user's computing device.

The user interface includes a variety of displayed informational tabs 510, with the “Home” tab 510a currently selected. As is shown, various information 515 that is personalized to the user may be displayed, and a variety of security-related information related to the current role of the user is also displayed in the current embodiment (e.g., information relating to individual terrorism suspects, terrorism groups, and terrorism cases with which the user is associated). Other users may instead receive other information via a similar user interface (e.g., another counter-terrorism user might receive information about other suspects, groups and terrorism cases, while a health professional might receive information about diseases, symptoms, and medical cases).

Another of the displayed informational tabs is the “Analytics” tab 510b, and FIG. 5B illustrates an example user interface that may be displayed to the user after the Analytics tab is selected. In particular, a variety of sub-tabs 520 are displayed, with a “Monthly Activities” sub-tab 520a currently selected. A variety of types of analyses of threat-related information that are related to the selected sub-tab are also displayed in the illustrated embodiment, such as based on predefined analysis definitions and/or on interactive user requests. As is shown, in the illustrated embodiment the display includes a chart 525a that shows the most active terrorist cells (e.g., for the most recent month) and a chart 525c that shows the most active terrorist regional cells. The charts have interactive controls 525b and 525d respectively to allow the user to control the analysis being performed in various ways, such as by modifying the time period for which the analysis is performed. Additional security-related information may also be available and/or displayed, such as by default or based on user selection, and in the illustrated embodiment a portion of a table 525e showing details about one or more types of activities is provided.

In the illustrated embodiment, the user can also interactively drill-down on illustrated information in order to refine the analyses being performed in various ways. For example, FIG. 5C illustrates a chart 530 that shows information specific to a particular terrorist group (in this example, Al Qaeda), and shows the most active regional cells for that group. Such an analysis may be selected by the user in various ways, such as by selecting the information representing that terrorist group in the chart 525a in FIG. 5B and/or by modifying an interactive control (not shown) for the chart 525c in FIG. 5B to limit the display to a particular group.

FIG. 5D illustrates yet another level of analysis refinement, and in particular displays a pie chart 535 that provides details about types of activities that are performed by a particular regional cell of a particular terrorist group for the period of time being analyzed. In the illustrated embodiment, the types of activities includes communication activities, financial activities, immigration activities, meeting activities, movement activities, and miscellaneous other activities. Such a chart could be selected by a user in various ways, such as by selecting information representing that regional cell in the chart 530 in FIG. 5C and/or by selecting appropriate information (not shown) in table 525e in FIG. 5B.

FIG. 5E illustrates yet another level of analysis refinement, and in particular illustrates a table 540 with information about communication activities of the specified regional cell of the specified terrorist group for the selected period of time. As with other illustrated types of analysis information, the illustrated table may be selected by the user in various ways, such as by selecting information that represents communication-type activities in pie chart 535 illustrated in FIG. 5D.

While not illustrated, the user in the illustrated embodiment can continue to refine and/or modify the analyses that are presented in various ways, such as to view information for other periods of time and to view other types of information.

In addition, in some embodiments indications of current values and/or changes in values for various types of security-related information over specified periods of time (e.g., to show current values and trends) may also be displayed.

For example, an investigative user such as the current counter-terrorism user may in some embodiments be able to view analyses that include the following:

| | | Example |
|---|---|---|
| | | Format |
| Name | Description | For Display |
| Activities by Time | Cumulative group & suspect | Column chart |
| Period (Week, Month, | activities for time period | |
| Quarter, Year) | (default is most recent 4 weeks) | |
| Activities by Type | Number of activities of the | Pie chart |
| and by Time Period | specified activity types for | |
| | time period (default is most | |
| | recent month) | |
| Activities by Group | Number of activities for top | Clustered bar |
| and by Time Period | groups for time period | chart |
| | (default is 10 groups & most | |
| | recent month) | |
| Activities by Suspect | Number of activities for top | Clustered bar |
| and by Time Period | suspects for time period | chart |
| | (default is 10 suspects & most | |
| | recent month) | |
| Top Groups by Open | Top groups by number of cases | Table |
| Cases and by Time | opened in time period | |
| Period | (default is 10 groups & most | |
| | recent three months) | |
| Top Cases by Activity | Top active cases by number of | Table |
| and by Time Period | new activities in time period | |
| | (default is 10 cases & most | |
| | recent month) | |
| Active Cases by Age | Number of active cases by | Column chart |
| | number of days since created - | |
| | less than 7, 7-14, 15-30, | |
| | 31-60, 61+ | |
| Active Cases | Number of active cases by | Column chart |
| by Threat Level | threat level - High, Medium, | |
| | Low | |
| Closed Cases | Number of cases closed in | Column chart |
| by Age and by Time | time period (default is | |
| Period | previous month) by difference | |
| | in days between creation and | |
| | close date - less than 7, 7-14, | |
| | 15-30, 31-60, 61+ | |
| Case Volume & Avg | Number of cases opened by | Column chart |
| Load by Agent, by | time unit (default is a | with line |
| Time Unit and by | month) within the time period | overlay for |
| Time Period | (default is prior 6 months) | average load |
| | on left axis, average number | |
| | of cases per agent on right | |
| | axis for time period | |

As is shown, each of the listed example types of analyses includes at least one measurement criteria for a type of security-related information being measured, and includes a time period for which the security-related information will be analyzed. The last example analysis type also includes a time unit within the time period (e.g., a month within 6-month time period), and the security-related information for each of the time units within the time period will be combined and measured individually, such as to show a trend within the time period. In some embodiments, such time units may also be specified for any analysis with a time period.

As an example of types of analyses for a user acting in a different role, a health care professional may be able to view analyses that include the following:

| | | Example |
|---|---|---|
| | | Format |
| Name | Description | For Display |
| Most Active Diseases | Top diseases by number of | Table |
| by Time Period | Service Requests (SRs) opened | |
| | in time period (default is | |
| | 10 cases & most recent month) | |
| SRs by Account | Number of SRs by state, city & | Map |
| Location and by | hospital in time period (default | |
| Time Period | is most recent month) | |
| SRs by Region and by | Number of SRs for time period | Table |
| Time Period | (default is most recent month) | |
| | by 4 major regions of US - | |
| | Northeast, Midwest, South, | |
| | West | |
| Open SRs by Age | Number of open SRs by number | Stacked |
| | of days since created - less | column |
| | than 7, 7-14, 15-30, 31-60, | chart broken |
| | 61+ | out by |
| | | disease |
| Top Cases by Activity | Top active cases by number of | Table |
| and by Time Period | new activities in time period | |
| | (default is 10 cases & most | |
| | recent month) | |
| Active Cases by Age | Number of active cases by | Column chart |
| | number of days since created - | |
| | less than 7, 7-14, 15-30, 31-60, | |
| | 61+ | |
| Closed Cases by Age | Number of cases closed in time | Column chart |
| and by Time Period | period (default is previous | |
| | month) by difference in days | |
| | between creation and close | |
| | date - less than 7, 7-14, | |
| | 15-30, 31-60, 61+ | |
| Case Volume & Avg. | Number of cases opened by time | Column chart |
| Load by Agent, | unit (default is a month) within | with line |
| by Time Unit and | the time period (default is | overlay for |
| by Time Period | prior 6 months) on left axis, | average load |
| | average number of cases per | |
| | agent on right axis for time | |
| | period | |

As with the analyses for the investigative agent role, in some embodiments any of the illustrated analyses with a time period may also allow a time unit within the time period to be specified and used.

FIG. 5F illustrates an alternative format for displaying changes in threat information over a period of time, such as to indicate trends. In particular, in the illustrated embodiment, the user interface includes a map 545 on which is displayed a variety of information about locations of terrorism suspects. While not illustrated here, the user may be able to view how locations of one or more of the suspects changes over, a selected period of time, such as by watching a corresponding icon for that suspect interactively move on the map and/or by viewing a series of two or more maps with changing locations. Other types of threat information with a geographic component can similarly be displayed in this manner. In addition, changes over time to this type of information as well as other threat information without a geographic component can be illustrated in other manners, such as by displaying a timeline with information shown for different points or periods of time.

FIG. 5G illustrates a variety of types of information analyses that can assist a user in identifying security threats. In particular, the “Threat Analysis” sub-tab 520b has been selected in the illustrated embodiment, and a variety of threat alert information 550, threat level information 555 and threat analysis information 560 is displayed. The threat alert information indicates summaries of various threat alerts that have been triggered and that may be relevant for the user, and the threat level information shows current threat levels for various watch list suspects. Various charts 560a-560d are also illustrated to indicate various types of threat information over specified periods of time that include the current month for pie chart 560b, the current week for bar chart 560a, and the current year for bar chart 560d. By viewing changing numbers of terrorist activities during each month (partially shown) for a specified period of time (e.g., a year), bar chart 560c can indicate a trend in the number of terrorist activities. In addition, the user can interactively select other types of analyses and/or modify existing analyses (e.g., by refining the analyses) to view information about changes in other types of terrorist-related information over time, such as to identify trends.

FIG. 5H illustrates a pop-up window 565 related to alert 550a, such as based on selection of that alert by the user or instead automatically based on a determination that the user is an appropriate recipient of the alert information. In the illustrated embodiment, the pop-up window includes a variety of details about the triggered alert, which in this example is based on multiple watch list suspects being in transit to a single city. In addition, a variety of interactive options 570 are presented to the user related to the alert, such as to re-execute the definition for the alert against current conditions, to review details about the alert definition, to clear this occurrence of the alert (e.g., to remove it from the displayed user interface of this user and/or of all users), and to close the pop-up window without clearing the alert. While not illustrated here, the system may have performed a variety of additional activities in response to the alert occurrence, such as notifying other users and/or interacting with other systems (e.g., computer systems of law enforcement officials in the city to which the watch list suspects are traveling or of the one or more transit companies on which the watch list suspects are traveling). Information about threat alerts may also be viewed by users in other ways in the illustrated embodiment, such as by selecting the “Outbound Alerts” tab 510c illustrated in FIG. 5A.

While not illustrated here, a variety of other data analysis techniques could similarly be used. For example, in some embodiments the performance of a first data analysis could trigger other the performance of other data analyses, such as regularly monitoring threat information to detect when a trend reaches a threshold, which triggers one or more additional analyses (e.g., that are not performed regularly). Such data analysis triggering can continue for multiple levels, such as if one of the additional analyses that is triggered identifies a possible threat in such a manner as to trigger other analyses to be performed.

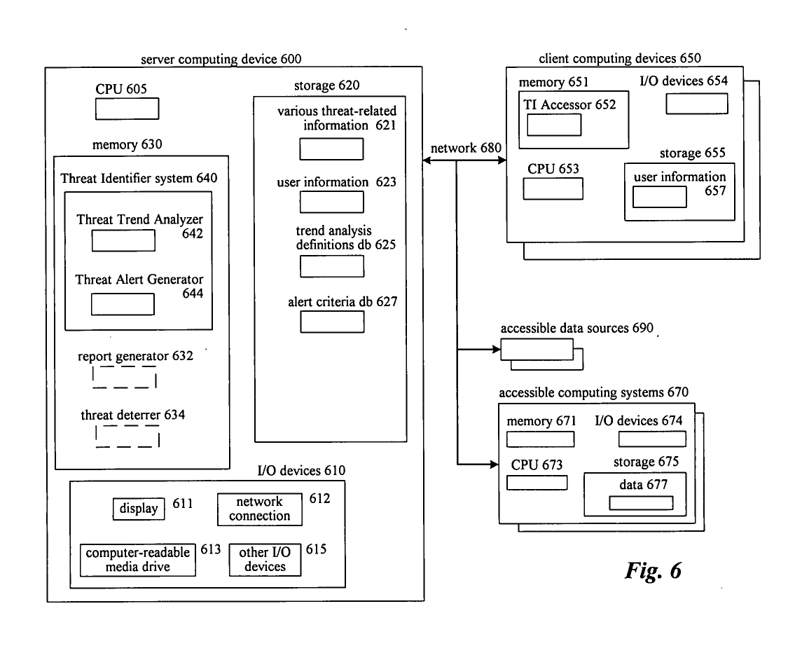

FIG. 6 is a block diagram illustrating an embodiment of a server computing device suitable for analyzing security-related information using the described techniques. In addition, client computing devices 650 are illustrated from which users can request specified types of analyses and/or receive information about performed analyses.

The computing system 600 includes a CPU 605, various I/O devices 610, storage 620, and memory 630. The I/O devices include a display 611, a network connection 612, a computer-readable media drive 613, and various other I/O devices 615. The computing device and the functionality it provides can be accessed by users in a variety of ways. For example, some users may have physical access to the computing system 600, and if so may use the I/O devices 610 to interact with the computing system. Alternatively, other users may use the remote client computing devices 650 to remotely access the computing system 600 (e.g., via the World Wide Web, such as over an intranet and/or the Internet).

An embodiment of a Threat Identifier system facility 640 is executing in memory 630, and it includes a Threat Trend Analyzer component 642 and a Threat Alert Generator component 644. The Threat Trend Analyzer component identifies trends in various security-related (or “threat-related”) information and the Threat Alert Generator component provides alerts when triggered by current conditions, as discussed in greater detail below.

In particular, the Threat Trend Analyzer component uses various trend analysis definitions from database 625 on storage to analyze various threat-related information in database 621 on storage in order to detect trends in the threat-related information, such as in response to requests from a user and/or to provide appropriate information to a user (e.g., based on a current role of the user). In some embodiments, the Threat Trend Analyzer component will also use various user information 623 from storage when performing an analysis for a user and/or providing analysis information to a user, such as to verify authority of the user to receive the information and/or to specialize the analysis performance or information providing in accordance with a role of the user and/or preferences of the user. The threat-related information used by the component can be retrieved from various sources, such as network-accessible data sources 690 and/or accessible computing systems 670 having data 677 on storage 675, whether instead of or in addition to having that information stored locally in database 621. In the illustrated embodiment, the accessible computing systems also include a CPU 673, various I/0 devices 674, and a memory 671.

In addition, the Threat Alert Generator component uses various alert criteria from database 627 on storage to determine when current conditions (e.g., of threat-related information in database 621) trigger the alert, such as in response to requests from a user and/or to provide appropriate information to a user (e.g., based on a current role of the user). In some embodiments, the Threat Alert Generator component will also use user information 623 when determining whether an alert is triggered for a user and/or when providing alert information to a user, such as to verify authority of the user to receive the information and/or to specialize the alert triggering determination or alert information providing in accordance with a role of the user and/or preferences of the user.

After a trend analysis is performed or an alert is triggered, an appropriate user (e.g., a user that defined or previously selected the trend analysis or alert, or instead a user having an appropriate current role) can be notified in various ways.

For example, in some embodiments the components 642 and 644 may directly notify the appropriate users, such as by sending messages to the users or by providing information to be presented to the users. In other embodiments, reports may be generated that include information about the trend analyses and/or triggered alerts, such as directly by the components 642 and 644 or instead in conjunction with an optional report generator component 632 executing in memory, and those reports can then be provided to the appropriate users.

In addition, in some embodiments users may request and/or retrieve information about trend analyses and/or triggered alerts, such as via a Threat Identifier Accessor component 652 (e.g., software specialized for the Threat Identifier system, or instead non-specific software such as a Web browser) executing in memory 651 of a client computing devices. The client computing devices also include a CPU 653, various I/O devices 654, and a storage 655 that may include various user information 657 (e.g., user preference information, information about a current role of the user, various authorization or access information to indicate types of information for which the user is appropriate, etc.) for one or more users of that computing device.

In addition, the components 642 and 644 may also interact with one or more other executing components based on trend analysis information or the triggering of an alert, such as an optional threat deterrer component 634 executing in memory 630, whether instead of or in addition to notifying appropriate users. Such interactions with other executing components may provide a variety of functionality and other benefits, such as to allow identified future threats to be quickly addressed in a proper manner.

Those skilled in the art will appreciate that in other embodiments the described functionality may be provided in other manners, such as by a single computing device of a user that performs analyses of information and notifies the user as appropriate. More generally, computing systems 600 and 650 are merely illustrative and are not intended to limit the scope of the present invention, and may be connected to other devices that are not illustrated (e.g., through one or more networks such as the Internet or via the World Wide Web). In addition, a “client” or “server” may comprise any combination of hardware or software that can interact as described, including computers, network devices, internet appliances, PDAs, wireless phones, pagers, electronic organizers, television-based systems and various other consumer products that include inter-communication capabilities. Moreover, the functionality provided by the illustrated components may in some embodiments be combined in fewer components or distributed in additional components. Similarly, in some embodiments the functionality of some of the illustrated components may not be provided and/or other additional functionality (e.g., other types of analyses) may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software modules and/or components may execute in memory on another device and communicate with the illustrated computing device via inter-computer communication. Some or all of the system components and data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

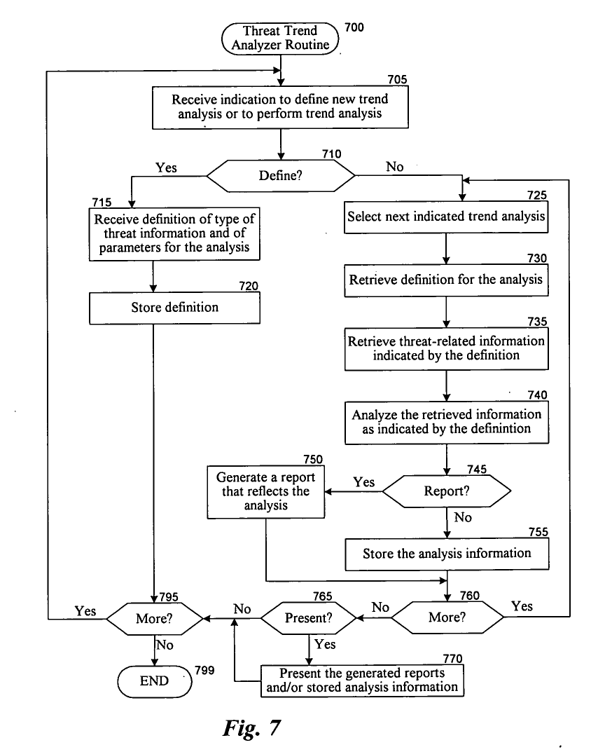

FIG. 7 is a flow diagram of an embodiment of a Threat Trend Analyzer routine 700. The routine analyzes various types of threat information in order to identify trends of concern, such as based on an analysis definition supplied by a user.

The routine begins at step 705 where an indication as received to specify a new threat trend analysis definition or instead to perform a trend analysis. An indication to perform a trend analysis may have a variety of forms, such as an indication to perform a periodic analysis as specified (e.g., once a day), an explicit user instruction, a receipt of appropriate threat information (e.g., a sufficient amount to reach an analysis threshold or of a type that triggers an analysis), etc. The routine then continues the step 710 to determine whether the received indication was to specify a new threat trend analysis definition, and if so continues to step 715 where a definition is received of a type of threat information and of various parameters for the analysis. The parameters for an analysis can be of various types, such as a time period for the analysis (e.g., the previous week or month), a report format for presenting analysis information, a threshold for a total amount or an amount of change that is considered significant, etc. While not illustrated here, in other embodiments a variety of other types of threat information analyses could also be defined, such as correlations between different types of threat information or between threat information and non-threat information, automated techniques to analyze various threat information to identify patterns and/or unusual information that varies from normal (e.g., based on data mining techniques), etc. After step 715, the routine continues to step 720 to store the supplied threat trend analysis definition.

If it was instead determined in step 710 that the received indication was to perform a threat trend analysis, the routine continues to step 725 to select the next indicated type of trend analysis, beginning with the first. In some embodiments, the specific types of trend analyses to be performed may be specified in step 705, while in other embodiments the analyses to be performed may be determined in other ways (e.g., based on a role of a user of the routine, on a predetermined schedule, on a type of threat information that has become available, etc.). The routine then continues to step 730 to retrieve a stored definition for the selected trend analysis, and then continues to step 735 to retrieve appropriate threat-related information indicated by the definition. In other embodiments, definitions may instead not be specified and stored in advance, such as when a user interactively specifies a trend analysis to be performed. The routine then continues to step 740 to analyze the retrieved threat information as indicated by the definition.

In step 745, the routine next determines whether to generate a report about the trend analysis that was performed, such as based on the threat trend analysis definition and/or in a manner specific to a user. If so, the routine continues to step 750 to generate a report that reflects the analysis, and if not the routine continues to step 755 to store the analysis information temporarily while the other analyses are performed (and optionally on a longer-term basis, such as for later use). After steps 750 or 755, the routine continues to step 760 to determine whether there are more analyses to perform, and if so returns to step 725. If not, the routine continues to step 765 to determine whether to present the analysis information to the user, and if so continues to step 770 to present the generated reports and/or the temporarily stored analysis information to the user, such as in a manner based on user preferences and/or the analysis definitions. After step 770 or 720, or if it was instead determined in step 765 not to present information to the user, the routine continues to step 795 to determine whether to continue. If so, the routine returns to step 705, and if not the routine continues to step 799 and ends.

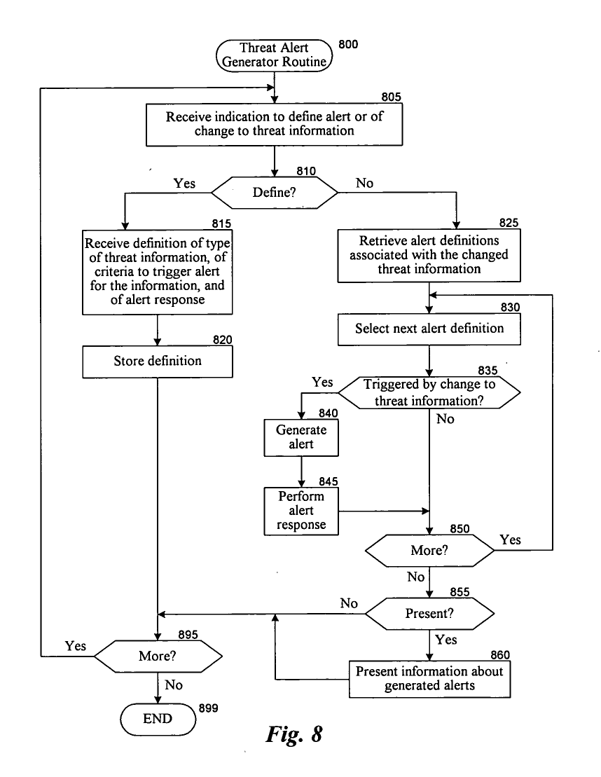

FIG. 8 is a flow diagram of an embodiment of a Threat Alert Generator routine 800. The routine identifies occurrences of interest related to threat information that trigger defined alerts, and provides alert information to users and/or other components as appropriate.

The routine begins at step 805 where an indication is received to define an alert type or of a change to threat information. The routine continues to step 810 to determine whether an alert is to be defined, and if so continues to step 815 to receive in the illustrated embodiment a definition of a type of threat information, of a criteria that when satisfied by threat information will trigger an alert (e.g., a threshold for a specified aspect of the information), and of a type of alert response. The routine then continues to step 820 to store the definition.

If it was instead determined in step 810 that a change to threat information has occurred, the routine continues to step 825 to retrieve alert definitions that are associated with the type of changed threat information. In other embodiments, alerts can be selected to be evaluated against current conditions (or other conditions, such as past conditions or predicted future conditions) in a variety of ways, such as based on an indication to perform a periodic evaluation as specified (e.g., once a day), an explicit user instruction, a receipt of appropriate threat information, etc. In step 830, the routine then selects the next retrieved alert definition, beginning with the first. In step 835, it is then determined whether that alert is triggered by the change to threat information, and if so continues to step 840 to generate an alert and to step 845 to perform the alert response for that alert definition (e.g., generating a pop-up window on the screens of one or more users, generating an instant communication to one or more users such as a phone call, page, instant message or SMS text, etc.).

After step 845, or if it was instead determined in step 835 that the selected alert was not triggered, the routine continues to step 850 to determine whether there are more alert definitions, and if so returns to step 830. If not, the routine continues to step 855 to determine whether to present alert information to a user (e.g., a summary of one or more current alerts), and if so continues to step 860 to present information about the generated alerts to the user. After steps 860 or 820, or if it was instead determined in step 855 not to present information, the routine continues to step 895 to determine whether to continue. If so, the routine returns to step 805, and if not the routine continues to step 899 and ends.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

1. (canceled)

2. A method in a computing system for identifying future terrorism threats based on analysis of terrorist activity information, the method comprising:
for each of multiple users,
determining a current role of the user related to fighting terrorism;
selecting one or more terrorism threat trend analysis (TTTA) definitions and one or more terrorism threat alert definitions for the user based at least in part on the determined current role, each TTTA definition specifying a measurement criteria for one of multiple types of terrorist activities and specifying a length of time, and each terrorism threat alert definition specifying a threshold related to one of the multiple types of terrorist activities; and
repeatedly assisting the user in identifying future terrorism threats in an automated manner by, for each of the selected TTTA definitions,
retrieving information about terrorist activities that occurred during a previous period of time of the length specified by the TTTA definition and that are of the type for the specified measurement criteria of the TTTA definition;
analyzing the retrieved terrorist activity information based on the measurement criteria specified by the TTTA definition in order to calculate activity threat values during the previous period of time and to detect a trend in the calculated activity threat values over the previous period of time;
generating a report that includes the calculated activity threat values in such a manner as to indicate the detected trend;
presenting the generated report to the user to enable the user to identify the detected trend in the determined activity threat values;
when the retrieved information is of the type for which one or more of the selected terrorism threat alert definitions has a specified threshold,
determining for each of those selected terrorism threat alert definitions whether one or more of the calculated activity threat values exceed the threshold specified by the terrorism threat alert definition; and
when a threshold specified by a terrorism threat alert definition is exceeded, immediately notifying the user of that terrorism threat alert; and
after the detecting of a trend and/or the determining that a threshold of a terrorism threat alert definition is exceeded, determining appropriate security personnel to be notified of the detected trend and/or of the exceeded terrorism threat alert threshold and notifying those security personnel of the detected trend and/or of the exceeded terrorism threat alert threshold,
so that users can identify future terrorism threats based on detected trends in terrorist activities and on thresholds for threat alerts that are exceeded;
wherein the terrorism threat alert definitions are each associated with one of the TTTA definitions in such a manner that the specified threshold for a terrorism threat alert definition corresponds to an amount of change in a detected trend of multiple calculated activity threat values from an analysis of terrorist activity information for the associated TTTA definition.

3. (canceled)

4. (canceled)

5. The method of claim 2 including, after the presenting of a generated report to a user, receiving instructions from the user to modify the analyzing of the retrieved terrorist activity information used to generate that report and presenting a revised report to the user that is generated based on a modified analysis of the retrieved terrorist activity information as indicated.

6. The method of claim 2 including selecting additional types of terrorist activity information analyses for at least one of the users and presenting reports to those users that are generated based on use of the selected additional types of analyses.

7. The method of claim 2 wherein, for each of at least one of the users, the selecting of the TTTA definitions and the terrorism threat alert definitions for the user is further based on information specific to that user.

8. The method of claim 2 wherein, for each of at least one of the users, the presenting of generated reports to the user and/or the notifying of the user of terrorism threat alerts is performed in a manner specific to that user.

9. The method of claim 2 wherein each of at least one of the TTTA definitions further specifies one or more terrorist groups and/or one or more terrorist suspects, and wherein the terrorist activity information that is retrieved for those TTTA definitions is further for activities performed by the specified terrorist groups or specified terrorist suspects.

10. The method of claim 2 wherein the current role of each of at least one of the users is an investigative counter-terrorism agent who is to prevent future terrorist threats and wherein the current role of each of at least one user other than the investigative counter-terrorism agent users is a health professional who is to address health problems caused by terrorist activities.

11. The method of claim 2 wherein the users are part of an organization that provides an information portal from which each of the users can repeatedly receive a page of information with information specific to that user for presentation on a computing device, wherein the analyzing of retrieved terrorist information for a user is performed as part of each generation of the page of information specific to that user, and wherein the reports generated from the analyzing are included as part of each generated page of information so that the generated reports can be presented to the user as part of the presenting of that page of information.

12. A computer-implemented method for identifying possible terrorism threats, the method comprising:
receiving information about terrorist activities that have occurred;
receiving an indication of a current user who has a specified current role related to fighting terrorism, the current role being one of multiple distinct roles that are each associated with threat analyses having associated criteria for analyzing terrorist activity information;
identifying based at least in part on the specified current role of the current user one or more threat analyses;
for each of the identified threat analyses, automatically analyzing the received terrorist activity information based on associated criteria for that threat analysis in order to determine whether the terrorist activities indicate a possible terrorism threat, the analyzing using the associated criteria for the threat analysis to measure one or more aspects of the terrorist activity information for each of multiple units of time and determining a trend in one or more of the measured aspects over a period of time that includes multiple of the time units; and
when the analyzing of the received terrorist activity information indicates a possible terrorism threat,
providing to the current user information related to the possible terrorism threat;
automatically determining an appropriate user to notify of the possible terrorism threat based at least in part on a type of the possible terrorism threat and on a current role of that user; and
notifying the determined user of the possible terrorism threat.

13. The method of claim 12 wherein the automatic analysis of the received terrorist activity information is performed in response to the receiving of the terrorist activity information.

14. The method of claim 12 wherein the identifying of the threat analyses is based on an indication of the identified threat analyses received from the current user, and wherein the automatic analysis of the received terrorist activity information is performed in response to the received indications.

15. The method of claim 14 wherein the appropriate user is determined to be the user from which the indication of the threat analyses is received.

16. The method of claim 12 wherein the automatic analysis of the received terrorist activity information is performed in response to an indication to provide information about terrorist activities to the determined appropriate user.

17. The method of claim 16 wherein the notifying of the determined user includes presenting information to that user about the analyzing of the received terrorist activity information.

18. The method of claim 17 wherein the presenting of the information to the user is performed as part of each load of an information page generated for that user.

19. (canceled)

20. (canceled)

21. The method of claim 12 wherein a possible terrorism threat is indicated by the analyzing when a determined trend satisfies a condition, and wherein the notifying of the determined user of the possible terrorist threat includes providing information about the determined trend.

22. The method of claim 12 wherein the analyzing further includes determining whether one or more of the measured aspects satisfies conditions for triggering an alert.

23. The method of claim 12 wherein a possible terrorism threat is indicated by the analyzing when an alert is triggered, and wherein the notifying of the determined user of the possible terrorist threat includes providing information about the alert.

24. The method of claim 12 wherein the notifying is performed in a real-time manner.

25. The method of claim 12 wherein the analyzing further includes comparing the received terrorist activity information to another type of information.

26. The method of claim 12 wherein the identifying of the threat analyses is based on a data mining analysis of information related to terrorist activities.

27. (canceled)

28. The method of claim 12 wherein the identifying of the threat analyses and the automatic analyzing of the received terrorist activity information are performed for each of multiple users such that distinct threat analyses are identified and used for the users.

29. The method of claim 12 wherein the determining of an appropriate user based on a type of a possible terrorism threat includes selecting a user whose current role includes addressing terrorism threats of that type.

30. The method of claim 12 wherein the terrorist activity information that is received is for activities performed by one or more specified terrorist groups.

31. The method of claim 12 wherein the terrorist activity information that is received is for activities performed by one or more specified terrorist suspects.

32. A computer-readable medium whose contents cause a computing device to assist in identifying security threats, by performing a method comprising:
identifying one or more threat analyses for analyzing information about occurrences related to one or more security threats, the identified threat analyses selected based at least in part on a current role of a current user;
for each of the identified threat analyses, attempting to identify a security threat by analyzing the security threat occurrence information, the analyzing including measuring one or more aspects of the security threat occurrence information for each of multiple units of time and determining a trend in one or more of the measured aspects over a period of time that includes multiple of the time units; and
when the analyzing of the received security threat occurrence information identifies a security threat, notifying a user of the identified security threat who is selected as appropriate based at least in part on the identified security threat.

33. The computer-readable medium of claim 32 wherein the security threat occurrence information includes information about terrorist activities that have occurred.

34. The computer-readable medium of claim 32 wherein the method includes determining the appropriate user for an identified security threat based on a type of the identified security threat.

35. The computer-readable medium of claim 32 wherein the computer-readable medium is a memory of a computing device.

36. The computer-readable medium of claim 32 wherein the computer-readable medium is a data transmission medium transmitting a generated data signal containing the contents.

37. The computer-readable medium of claim 32 wherein the contents are instructions that when executed cause the computing device to perform the method.

38. A computing device for assisting in identifying possible security threats, comprising:
a threat analyzer component that is capable of identifying a threat analysis that has an associated criteria for analyzing security threat occurrence information and of analyzing the security threat occurrence information based on the associated criteria in order to identify a possible security threat, the analyzing using the associated criteria for the threat analysis to determine a trend over a period of time in one or more aspects of the security threat occurrence information; and
a threat notifier component that is capable of notifying a user of an identified possible security threat, the user selected as appropriate for the identified possible security threat based at least in part on a current role of the user.

39. The computing device of claim 38 wherein the threat analyzer component and the threat notifier component are executing in memory of the computing device.

40. A computer system for assisting in identifying possible security threats, comprising:
means for identifying a threat analysis that has an associated criteria for analyzing security threat occurrence information and for analyzing the security threat occurrence information based on the associated criteria in order to identify a possible security threat, the analyzing using the associated criteria for the threat analysis to determine a trend over a period of time in one or more aspects of the security threat occurrence information; and
means for notifying a user of an identified possible security threat after the user is identified as appropriate for the identified possible security threat based at least in part on a current role of the user.

41. A computer-implemented method for identifying potential terrorist acts, the method comprising:
receiving information about terrorist activities that have occurred;
identifying one or more threat analyses that each have an associated criterion for analyzing the received terrorist activity information;
for each of the identified threat analyses, automatically analyzing the received terrorist activity information based on the associated criterion for that threat analysis in order to determine whether the terrorist activities indicate a potential terrorist act, the analyzing including determining a trend over a period of time in one or more aspects of the received terrorist activity information; and
when the analyzing of the received terrorist activity information indicates a potential terrorist act,
identifying one or more individuals who will perform the potential terrorist act;
selecting one or more agents appropriate to directly prevent the potential terrorist act, the selecting based on a type of the potential terrorist act and on current roles of the agents that are related to preventing terrorist acts of that type; and
notifying the selected agents of the potential terrorist act and the identified individuals in order to directly prevent the potential terrorist act.
